(19) United States
(12) Patent Application Publication
(10) Pub. No.: US 2008/0024641 A1
(43) Pub. Date: Jan. 31, 2008

(54) Index editing device for digital camera

(76) Inventor: Wei Hsu, Taipei County (TW)

Correspondence Address: Wei Hsu, P.O. Box 44-2049, Taipei, 10668, omitted

(21) Appl. No.: 11/493,546

(22) Filed: Jul. 27, 2006

(51) Int. Cl. H04N 5/222

(52) U.S. Cl. 348/333.01

(57) ABSTRACT

A digital image taking device such as digital camera includes lens unit on one side of the case and a screen and a control panel located on the other side of the case. The control panel includes operation buttons installed thereon so as to operate the digital camera. A character editing device is displayed on the screen or installed on the control panel, and is cooperated with an on-board data source. The character editing device has editing feature to put characters chosen from the data source on the digital photo displayed on the screen. The characters and the digital photo can be saved in the memory card.

### BACKGROUND OF THE INVENTION

(1) Field of the Invention

The present invention relates to an index editing device for digital video camera or digital camera so as to directly put characters on the photos in the screen of the digital camera.

(2)Description of the Prior Art

A conventional digital camera can take a shot without using conventional film and the photo can be stored in digital form which can be stored in memory card in the digital camera such that the user can take a huge number of shots as long as the capacity of the memory card allows. The digital photos can be printed to be paper photo easily. However, the conventional digital camera cannot put any index or description on the photos so that when printing these digital photos from the memory card, the user may not recall the specific time and motion when taking that shot.

The present invention intends to provide an index editing device which can directly put index or characters on the photos after shooting.

### SUMMARY OF THE INVENTION

The present invention relates to a digital image taking device that comprises a case having a screen on one side thereof and a control panel is located beside the screen. The control panel includes operation buttons 121 installed thereon so as to operate the digital image taking device. A character editing device is displayed on the screen and cooperated with an on-board data source. The character editing device has editing feature to put characters chosen from the data source on the digital photo displayed on the screen. The characters and the digital photo are able to be saved to the memory card.

The primary object of the present invention is to provide a character editing device cooperated with the digital image taking device such as digital camera or digital video camera. The character editing device is able to put characters on the image right on the screen and save the image together with the characters to the memory card.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the digital image taking device with the first embodiment of the character editing device on the screen;

FIG. 2 shows the digital image taking device with the second embodiment of the character editing device on the screen;

FIG. 3 shows the digital image taking device with the third embodiment of the character editing device on the control panel;

FIG. 4 shows the digital image taking device with the first embodiment of the input device connected thereto;

FIG. 5 shows the digital image taking device with the second embodiment of the input device connected thereto;

FIG. 6 shows the digital image taking device with the third embodiment of the input device wirelessly connected thereto;

FIG. 7 shows the digital image taking device with the fourth embodiment of the input device wirelessly connected thereto;

FIG. 8 shows the digital image taking device with the fifth embodiment of the input device wirelessly connected thereto, and

FIG. 9 shows the digital image taking device with the six embodiment of the input device connected thereto.

### DETAILED DESCRIPTION OF THE PREFERRED EMBODIMENTS

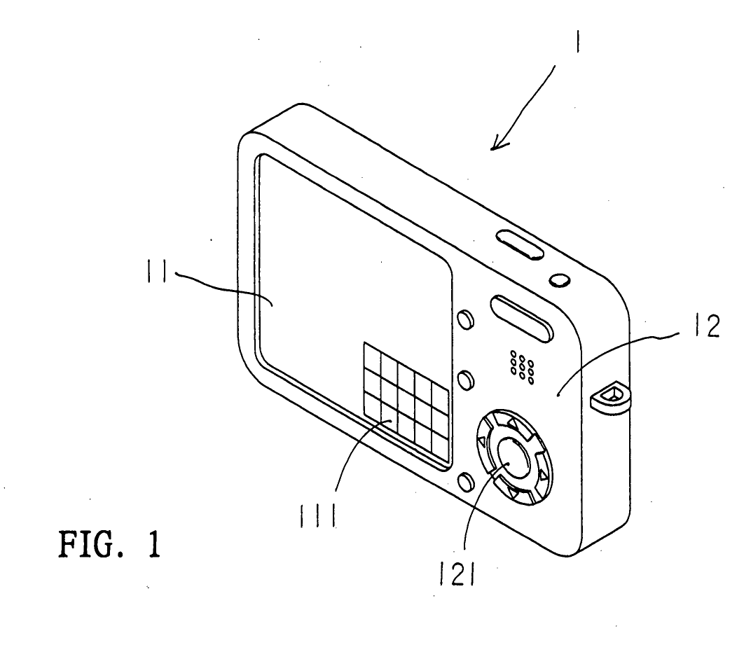

Referring to FIG. 1, the digital image taking device 1 such as a digital camera or digital video camera of the present invention comprises a case having a lens set (not shown) on one side thereof and a screen 11 on the other side of the case. A control panel 12 is located beside the screen 11 and operation buttons 121 are installed on the control panel 12 so as to operate the digital image taking device 1. A battery, a memory, a circuit board are receive din the case.

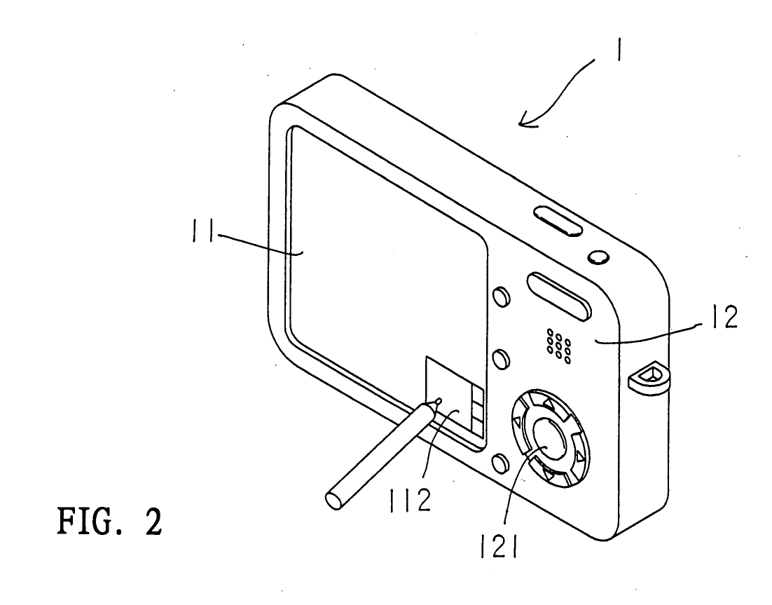

A character editing device is displayed on the screen 11 and cooperated with an on-board data source. The character editing device has editing feature to put characters chosen from the data source on the digital photo displayed on the screen 11. The characters and the digital photo can be saved to the memory card. The position of the character editing device is located at a desired position of the screen 11 and preferably located at a right lower corner of the screen 11. The character editing device can be a touch keypad 111 as shown in FIG. 1 or a writing board 112 cooperated with an optical pen as shown in FIG. 2.

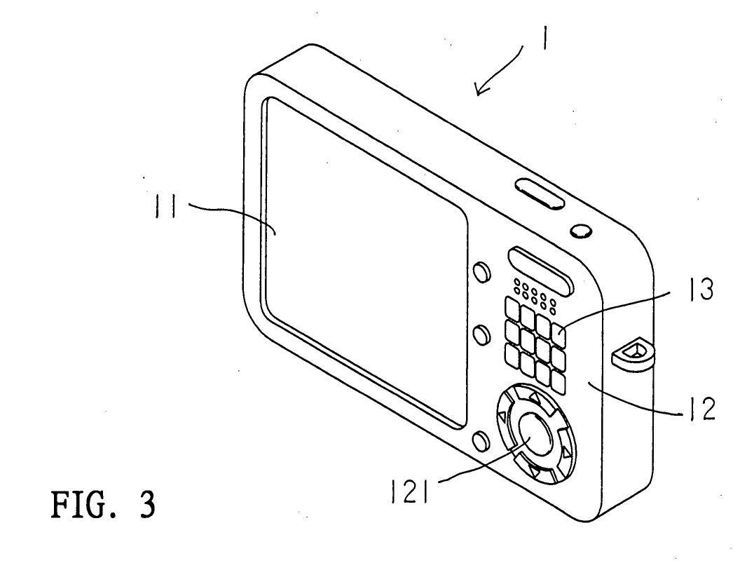

As shown in FIG. 3, the character editing device can also be character buttons 13 installed on the control panel 12 and the user operates the character buttons 13 to display characters, words, or patterns on the image on the screen 11.

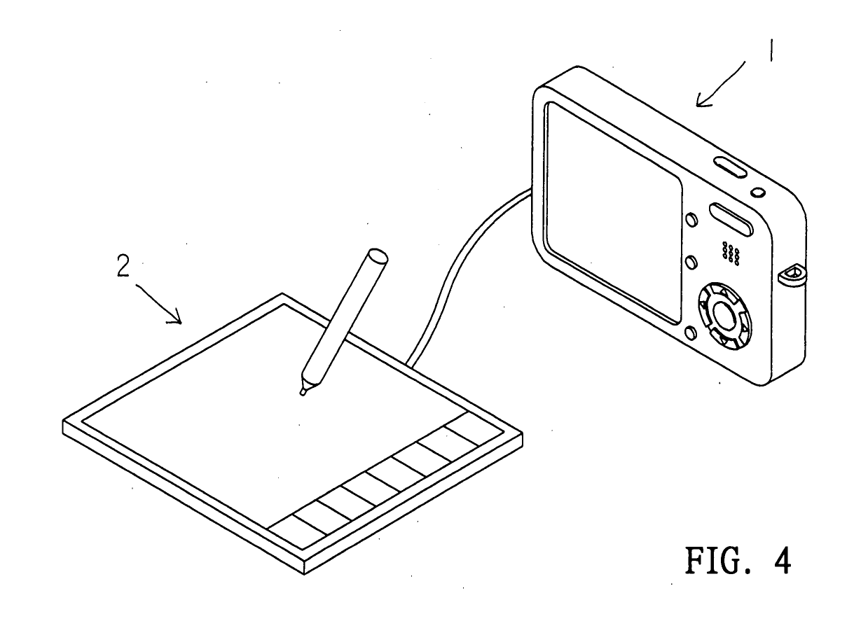

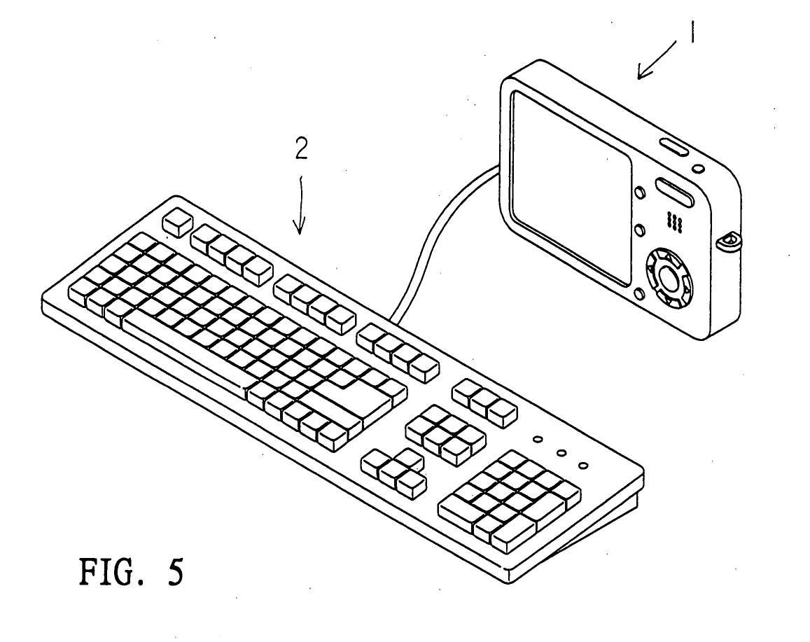

As shown in FIGS. 4 and 5, an input device 2 can be connected to the digital image taking device 1 by a proper cable and cooperated with an on-board data source in the digital image taking device 1. The input device 2 has editing feature to put characters chosen from the data source on the digital photo displayed on the screen 11. The characters and the digital photo can also be saved in the memory card. The input device 2 can be a writing board cooperated with an optical pen or a keyboard.

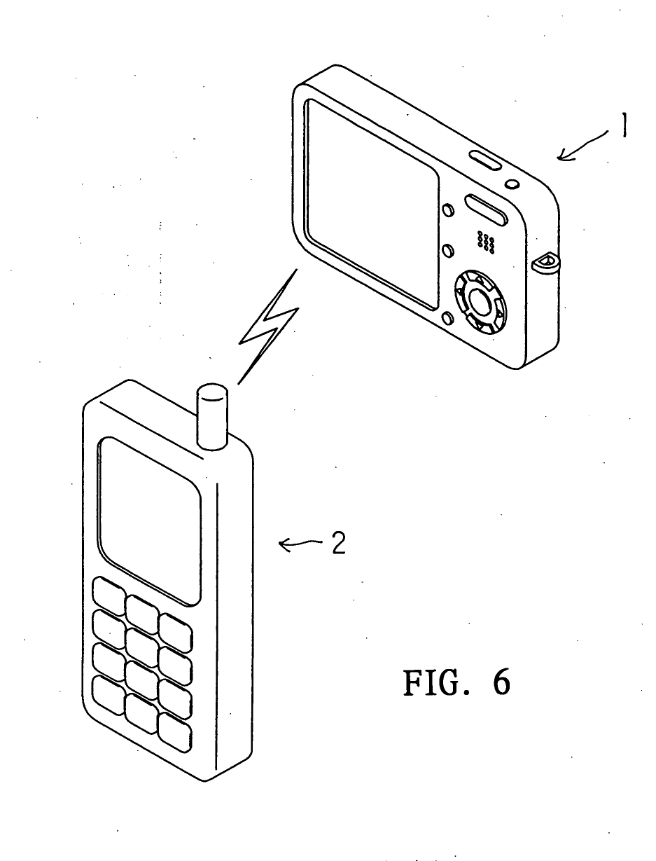

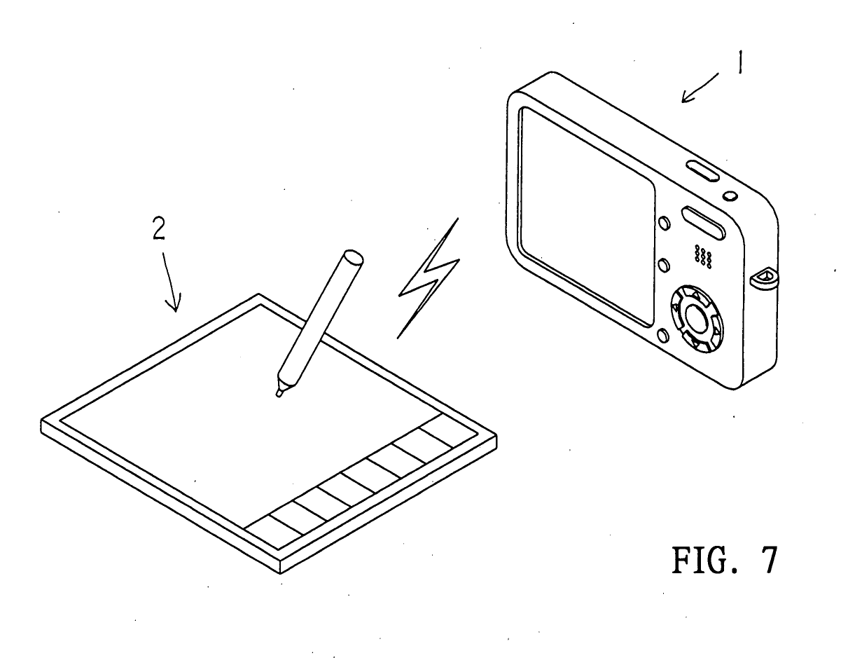

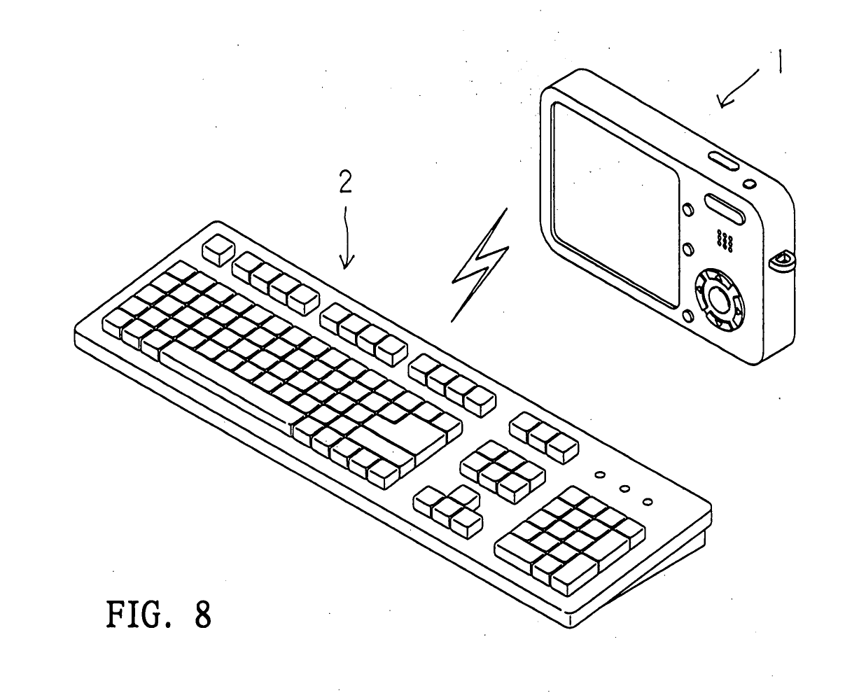

As shown in FIGS. 6 to 8, the digital image taking device 1 has an on-board wireless signal receiving device so that the input device 2 can be a cellular phone, a wireless writing board cooperated with an optical pen, or a wireless keyboard.

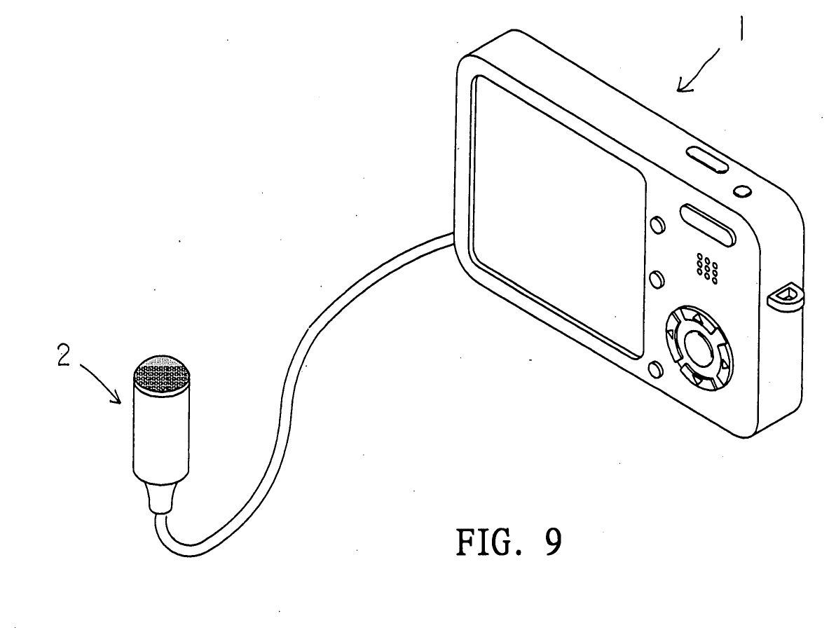

FIG. 9 shows that the digital image taking device 1 has an on-board voice recognition device and the input device 2 can be a microphone which can be connected to the digital image taking device 1 by a cable or the microphone can be a wireless microphone. Therefore, when the user speaks to the microphone, the on-board voice recognition device can transfer the voice commands into characters.

While we have shown and described the embodiment in accordance with the present invention, it should be clear to those skilled in the art that further embodiments may be made without departing from the scope of the present invention.

What is claimed is:

1. A digital image taking device comprising:
a case having a screen on one side thereof and a control panel located beside the screen, operation buttons installed on the control panel, and
a character editing device displayed on the screen and cooperated with an on-board data source, the character editing device having editing feature to put characters chosen from the data source on the digital photo displayed on the screen, the characters and the digital photo being savable in the memory card.

2. The digital image taking device as claimed in claim 1, wherein the character editing device is a touch keypad.

3. The digital image taking device as claimed in claim 1, wherein the character editing device is a writing board cooperated with an optical pen.

4. The digital image taking device as claimed in claim 1, wherein the digital image taking device is a digital camera.

5. The digital image taking device as claimed in claim 1, wherein the digital image taking device is a digital video camera.

6. A digital image taking device comprising:
a case having a screen on one side thereof and a control panel located beside the screen, operation buttons installed on the control panel, and
a plurality of character buttons installed on the control panel and cooperated with an on-board data source, the character buttons having editing feature to put characters chosen from the data source on the digital photo displayed on the screen, the characters and the digital photo being savable in the memory card.

7. A digital image taking device comprising:
a case having a screen on one side thereof and a control panel located beside the screen, operation buttons installed on the control panel, and
an input device connected to the digital image taking device and cooperated with an on-board data source, the input device having editing feature to put characters chosen from the data source on the digital photo displayed on the screen, the characters and the digital photo being savable in the memory card.

8. The digital image taking device as claimed in claim 7, wherein the input device is a writing board cooperated with an optical pen.

9. The digital image taking device as claimed in claim 7, wherein the input device is a keyboard.

10. The digital image taking device as claimed in claim 7, wherein the digital image taking device has an on-board wireless signal receiving device.

11. The digital image taking device as claimed in claim 10, wherein the input device is a cellular phone.

12. The digital image taking device as claimed in claim 7, wherein the digital image taking device has an on-board voice recognition device and the input device is a microphone.

13. The digital image taking device as claimed in claim 10, wherein the digital image taking device has an on-board voice recognition device and the input device is a microphone.
